(19) United States
(12) Patent Application Publication
(10) Pub. No.: US 2024/0365109 A1
(43) Pub. Date: Oct. 31, 2024

(54) TERMINAL CAPABILITY REPORTING METHOD AND APPARATUS, AND NON-TRANSITORY STORAGE MEDIUM

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 18/566,053

(22) PCT Filed: May 31, 2021
(86) PCT No.: PCT/CN2021/097335

§ 371 Date: Nov. 30, 2023

(51) Int. Cl. H04W 8/24; H04L 5/14

(52) U.S. Cl. CPC H04W 8/24; H04L 5/14

(57) ABSTRACT

A terminal capability reporting method and apparatus, and a non-transitory storage medium. The terminal capability reporting method includes: reporting a first terminal capability to a base station, wherein the first terminal capability comprises supporting a full-duplex communication mode.

### CROSS-REFERENCE TO RELATED APPLICATIONS

The present application is a U.S. national phase application of International Application No. PCT/CN2021/097335, filed on May 31, 2021, the disclosure of which is incorporated herein by reference in its entirety for all purposes.

BACKGROUND

In the future, 5th Generation Mobile Communication Technology (5G) network services will be more diverse, have higher speeds, and require more connections. Therefore, a spectrum efficiency of the 5G network needs to be greatly improved.

A full-duplex technology is an important candidate technology that can meet the requirements for improving the spectrum efficiency in the 5G networks. The full-duplex technology means that a terminal can simultaneously transmit and receive data at the same time and/or on the same frequency bandwidth.

### SUMMARY

The present disclosure relates to the field of communications, and in particular to a terminal capability reporting method and device, and a storage media.

Embodiments of the present disclosure provide a terminal capability reporting method and device, and a non-transitory storage medium, which can be applied to cellular networking such as 5G networks and future 6G networks.

According to a first aspect of the embodiments of the present disclosure, a terminal capability reporting method is provided, the method is performed by a terminal and includes:
reporting first terminal capability to a base station, where the first terminal capability includes supporting a full-duplex communication mode.

According to a second aspect of the embodiments of the present disclosure, a terminal capability reporting method is provided, the method is performed by a base station and includes:
receiving first terminal capability reported by a terminal, wherein the first terminal capability includes supporting a full-duplex communication mode; and
determining, based on the first terminal capability, that the terminal supports the full-duplex communication mode.

According to a third aspect of the embodiments of the present disclosure, a communication device is provided, including:
a processor; and
a memory configured to store instructions executable by the processor,
wherein the processor is configured to perform the terminal capability reporting method in any one of the first aspect as described above.

It should be understood that the above general description and the following detailed description are only illustrative and explanatory, and should not limit the present disclosure.

### BRIEF DESCRIPTION OF THE DRAWINGS

The drawings herein are incorporated in and constitute a part of the specification, illustrate embodiments consistent with the present disclosure, and together with the description serve to explain the principles of the present disclosure.

FIG. 1 is a schematic flowchart of a terminal capability reporting method according to an illustrative embodiment.

FIG. 2 is a schematic flowchart of another terminal capability reporting method according to an illustrative embodiment.

FIG. 3 is a schematic flowchart of another terminal capability reporting method according to an illustrative embodiment.

FIG. 4 is a schematic flowchart of another terminal capability reporting method according to an illustrative embodiment.

FIG. 5 is a schematic flowchart of another terminal capability reporting method according to an illustrative embodiment.

FIG. 6 is a schematic flowchart of another terminal capability reporting method according to an illustrative embodiment.

FIG. 7 is a schematic flowchart of another terminal capability reporting method according to an illustrative embodiment.

FIG. 8 is a block diagram of a terminal capability reporting device according to an illustrative embodiment.

FIG. 9 is a block diagram of another terminal capability reporting device according to an illustrative embodiment.

FIG. 10 is a schematic structural diagram of a communication device according to an illustrative embodiment of the present disclosure.

FIG. 11 is a schematic structural diagram of another communication device according to an illustrative embodiment of the present disclosure.

### DETAILED DESCRIPTION

Illustrative embodiments will be described in detail here, examples of which are illustrated in the accompanying drawings. When the following description refers to the accompanying drawings, the same numerals in different drawings represent the same or similar elements unless otherwise indicated. The implementations described in the following illustrative embodiments do not represent all implementations consistent with the present disclosure. Rather, they are merely examples of devices and methods consistent with some aspects of the present disclosure as detailed in the appended claims.

The terms used in the present disclosure are for the purpose of describing specific embodiments only and are not intended to limit the present disclosure. As used in the present disclosure and the appended claims, the singular forms “a,” “an” and “the” are intended to include the plural forms as well, unless the context clearly dictates otherwise. It will also be understood that the term “and/or” as used herein refers to and includes any and all possible combinations of at least one associated item listed.

It should be understood that although the terms first, second, third, etc. may be used in the present disclosure to describe various information, the information should not be limited to these terms. These terms are only used to distinguish information of the same type from each other. For example, without departing from the scope of the present disclosure, the first information may also be called the second information, and similarly, the second information may also be called the first information. Depending on the context, the word “if” as used herein may be interpreted as “when” or “upon” or “in response to determining . . . ”.

A terminal capability reporting method provided by the present disclosure is first introduced below from the terminal side.

An embodiment of the present disclosure provides a terminal capability reporting method. Refer to FIG. 1, which is a flow chart of a terminal capability reporting method according to an embodiment. The method can be performed by a terminal, which includes but is not limited to a handheld terminal, a desktop computer, a notebook computer, a wearable smart device, etc. The method may include the following steps.

In step 101, first terminal capability is reported to a base station, where the first terminal capability includes supporting a full-duplex communication mode.

In the above embodiment, the terminal may report the first terminal capability to the base station, where the first terminal capability includes supporting a full-duplex communication mode. Based on the first terminal capability, the base station determines that the terminal supports the full-duplex communication mode. Subsequently, the base station determines a full-duplex communication mode that is more suitable for the terminal. The purpose of reporting to the network side device that the terminal supports the full-duplex communication mode can be realized, which provides condition for applying the full-duplex technology in cellular networking.

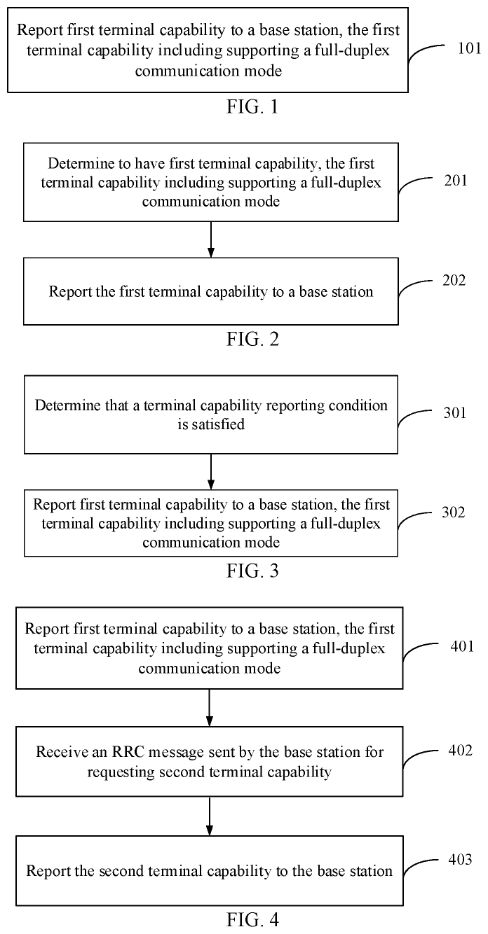

In some embodiments, refer to FIG. 2, which is a flow chart of a terminal capability reporting method according to an embodiment. The method can be performed by the terminal. The method may include the following steps.

In step 201, it is determined to have first terminal capability, where the first terminal capability includes supporting a full-duplex communication mode.

In step 202, the first terminal capability is reported to the base station.

In the above embodiment, a terminal that supports the full-duplex communication mode may report the first terminal capability to the base station, and correspondingly, a terminal that does not support the full-duplex communication may not report the first terminal capability, which can enable the base station to determine that the terminal supports the full-duplex communication mode while saving terminal resources. The purpose of reporting to the network side device that the terminal supports the full-duplex communication mode is realized, which provides condition for applying the full-duplex technology in cellular networking.

In some embodiments, refer to FIG. 3, which is a flow chart of a terminal capability reporting method according to an embodiment. The method can be performed by the terminal. The method may include the following steps.

In step 301, it is determined that a terminal capability reporting condition is satisfied.

In an implementation, the terminal may determine that the terminal capability reporting condition is satisfied when determining that Radio Resource Control (RRC) connection reconfiguration is being performed.

In an implementation, the terminal may determine that the terminal capability reporting condition is satisfied when determining that the RRC connection re-establishment is being performed.

In an implementation, the terminal may determine that the terminal capability reporting condition is satisfied when determining that the RRC connection resume is being performed.

In an implementation, the terminal may determine that the terminal capability reporting condition is satisfied when determining that the RRC connection is being setup.

In step 302, first terminal capability is reported to a base station, where the first terminal capability includes supporting a full-duplex communication mode.

In the above embodiment, the terminal can report the first terminal capability to the base station in the cases where the terminal capability reporting condition is satisfied, which is simple to implement and has high availability.

In some embodiments, the terminal may report the first terminal capability through an RRC message.

In an implementation, in a case where it is determined that Radio Resource Control (RRC) connection reconfiguration is being performed, the terminal can report the first terminal capability through an RRCConnectionReconfigurationComplete (RRC connection reconfiguration complete) message or an RRCReconfigurationComplete (RRC reconfiguration complete) message.

In an implementation, in a case where it is determined that RRC connection re-establishment is being performed, the terminal can report the first terminal capability through an RRCConnectionReestablishmentComplete (RRC connection reestablishment complete) message or an RRCReestablishmentComplete (RRC reestablishment complete) message.

In an implementation, in a case where it is determined that RRC connection resume is being performed, the terminal can report the first terminal capability through an RRCConnectionResumeComplete (RRC connection resume complete) message or an RRCResumeComplete (RRC resume complete) message.

In an implementation, in a case where it is determined that the RRC connection is being setup, the terminal can report the first terminal capability through an RRCConnectionSetupComplete (RRC connection setup complete) message or an RRCSetupComplete (RRC setup complete) message.

In the above embodiments, the terminal can report the first terminal capability through the RRC message, which achieves the purpose of reporting to the network side device that the terminal supports the full-duplex communication mode, and provides conditions for applying the full-duplex technology in cellular networking.

In some embodiments, the terminal may report the RRC message including first information element to the base station. The first information element is used to indicate having the first terminal capability. In some examples, the first information element may be an information element newly added in the RRC message, for example, it may be a FullDuplexAvailable information element.

In some embodiments, the terminal may report an RRC message including first indication information to the base station. The first indication information is used to indicate having the first terminal capability. The first indication information may be multiplexed in an original information element of the RRC message, or a new information element may be added to the RRC message, and the first indication information may be added in the newly added information element, which is not limited in the present disclosure.

In the above embodiments, the purpose of reporting to the network side device that the terminal supports the full-duplex communication mode can be achieved, which provides conditions for applying the full-duplex technology in cellular networking.

In some embodiments, refer to FIG. 4, which is a flow chart of a terminal capability reporting method according to an embodiment. The method can be performed by the terminal. The method may include the following steps.

In step 401, first terminal capability is reported to a base station, where the first terminal capability includes supporting a full-duplex communication mode.

In step 402, an RRC message sent by the base station for requesting second terminal capability is received.

In an embodiment of the present disclosure, the second terminal capability may be terminal capability that is more detailed than the first terminal capability and corresponds to the full-duplex communication mode. The second terminal capability includes but is not limited to at least one of the following: frequency information that supports the full-duplex communication mode; time information that supports the full-duplex communication mode; and a full-duplex communication mode that is supported.

In an implementation, the RRC message used to request the second terminal capability may be a UEInformationRequest message.

In step 403, the second terminal capability is reported to the base station.

In the above embodiments, the terminal may first report the first terminal capability to the base station, and the first terminal capability includes supporting a full-duplex communication mode. Further, after receiving the RRC message sent by the base station for requesting the second terminal capability, the terminal reports the second terminal capability to the base station. The second terminal capability may be the terminal capability that is more detailed than the first terminal capability and corresponds to the full-duplex communication mode. It facilitates the base station to subsequently determine a full-duplex communication mode that is more suitable for the terminal, and has high availability.

In some embodiments, the terminal may report the second terminal capability to the base station through an RRC message. In some examples, the RRC message for reporting the second terminal capability may be a UEInformationResponse message.

In an implementation, the terminal may report an RRC message including a second information element to the base station, where the second information element includes the second terminal capability. In some examples, the second information element may be an original information element in the RRC message, or may be a newly added information element, which is not limited in the present disclosure.

In a case where the second information element is an information element newly added in the RRC message, the second information element may be a FullDuplexReport information element.

In the above embodiments, the terminal can report the second terminal capability to the base station through the RRC message, which is simple to implement and has high availability.

In some embodiments, the frequency information supporting the full-duplex communication mode included in the second terminal capability may refer to a frequency or a frequency range in which the terminal supports the full-duplex communication mode.

For example, the terminal supports the full-duplex communication mode in the frequency range from F1 to F3. For another example, the terminal supports the full-duplex communication mode in a frequency F4.

The time information supporting the full-duplex communication mode included in the second terminal capability may refer to a time or a time period in which the terminal specifically supports the full-duplex communication mode. For example, the terminal supports full-duplex communication mode during the time period from t1 to t2.

The full-duplex communication mode included in the second terminal capability may be a same-time and same-frequency full-duplex communication mode, a same-time and different-frequency full-duplex communication mode, or a same-frequency and different-time full-duplex communication mode.

The same-time and same-frequency full-duplex communication mode means that the terminal can send and receive data simultaneously in the same time period and the same frequency. The same-time and different-frequency full-duplex communication mode means that the terminal can send and receive data simultaneously on different frequencies in the same time period. The same-frequency and different-time full-duplex communication mode means that the terminal can send and receive data simultaneously in different time periods in the same frequency band.

The terminal capability reporting method provided by the present disclosure is then introduced below from the base station side.

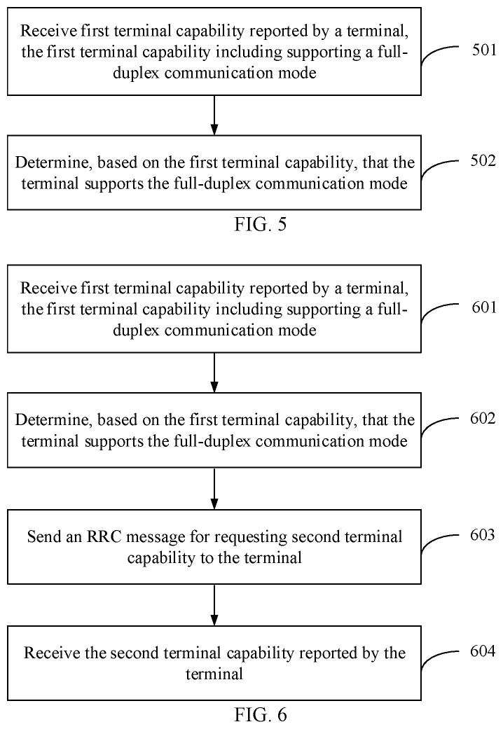

An embodiment of the present disclosure provides a terminal capability reporting method. Refer to FIG. 5, which is a flow chart of a terminal capability reporting method according to an embodiment. The method can be used in a base station, which includes but is not limited to a gNB base station in a 5G system, an eNB base station in a Long Term Evolution (LTE) system, etc. The method may include the following steps.

In step 501, first terminal capability reported by a terminal is received, where the first terminal capability includes supporting a full-duplex communication mode.

In step 502, it is determined, based on the first terminal capability, that the terminal supports the full-duplex communication mode.

In the above embodiment, the base station can determine that the terminal supports the full-duplex communication mode based on the first terminal capability reported by the terminal, and can subsequently determine a full-duplex communication mode that is more suitable for the terminal, which provides conditions for the application of the full-duplex technology in cellular networking.

In some embodiments, refer to FIG. 6, which is a flow chart of a terminal capability reporting method according to an embodiment. The method can be used in a base station. The method can include the following steps.

In step 601, first terminal capability reported by a terminal is received, where the first terminal capability includes supporting a full-duplex communication mode.

In step 602, it is determined, based on the first terminal capability, that the terminal supports the full-duplex communication mode.

In step 603, an RRC message for requesting second terminal capability is sent to the terminal.

In an implementation, the RRC message used to request the second terminal capability may be a UEInformationRequest message.

In step 604, the second terminal capability reported by the terminal is received.

In the above embodiment, after determining that the terminal supports the full-duplex communication mode, the base station may send an RRC message for requesting the second terminal capability to the terminal, thereby receiving the second terminal capability reported by the terminal. The second terminal capability may be terminal capability that is more detailed than the first terminal capability and corresponds to the full-duplex communication mode. The base station can subsequently configure a more appropriate full-duplex communication mode for the terminal based on the second terminal capability.

In some embodiments, the base station may send an RRC message including request information to the terminal, where the request information is used to request the second terminal capability.

In an implementation, the request information can be multiplexed in an original information element of the RRC message.

In another implementation, the base station can add a new information element in the RRC message. For example, the new information element is a FullDuplexReq (full-duplex request) information element, and the base station adds the request information in the new information element.

In the above embodiment, the base station can request the second terminal capability through the RRC message, which is simple to implement and has high availability.

In some embodiments, the second terminal capability includes at least one of the following: frequency information that supports the full-duplex communication mode; time information that supports the full-duplex communication mode; and a supported full-duplex communication mode.

In some embodiments, the base station may send second indication information to the terminal based on the second terminal capability reported by the terminal, where the second indication information is used to indicate a full-duplex communication mode for the terminal.

In the above embodiment, the base station can determine a more appropriate full-duplex communication mode for the terminal based on the second terminal capability, which provides conditions for applying the full-duplex technology in cellular networking.

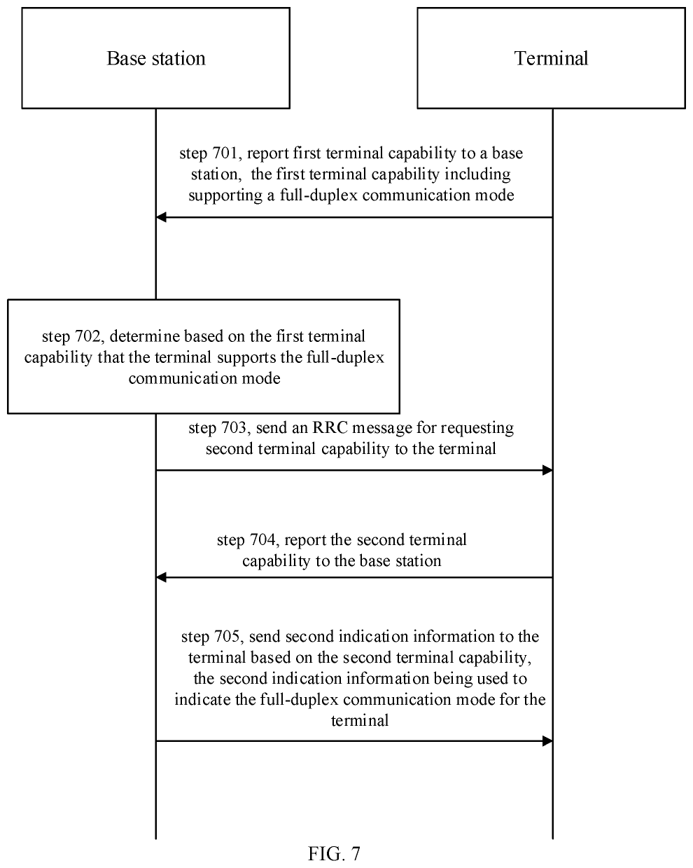

In some embodiments, refer to FIG. 7, which is a flow chart of a terminal capability reporting method according to an embodiment. The method may include the following steps.

In step 701, a terminal reports first terminal capability to a base station, where the first terminal capability includes supporting a full-duplex communication mode.

In step 702, the base station determines, based on the first terminal capability, that the terminal supports the full-duplex communication mode.

In step 703, the base station sends an RRC message for requesting second terminal capability to the terminal.

In step 704, the terminal reports the second terminal capability to the base station.

In step 705, the base station sends second indication information to the terminal based on the second terminal capability, where the second indication information is used to indicate the full-duplex communication mode for the terminal.

In the above embodiment, the terminal may report the first terminal capability to the base station, where the first terminal capability includes supporting the full-duplex communication mode. Based on the first terminal capability, the base station determines that the terminal supports the full-duplex communication mode. Further, the base station may send the RRC message for requesting the second terminal capability to the terminal, the terminal reports the second terminal capability to the base station, and the base station determines a full-duplex communication mode that is more suitable for the terminal based on the second terminal capability. The present disclosure can realize the purpose of reporting to the network side device that the terminal supports the full-duplex communication mode, and provides conditions for applying the full-duplex technology in cellular networking.

Corresponding to the foregoing terminal capability reporting method embodiments, the present disclosure also provides terminal capability reporting device embodiments.

Refer to FIG. 8, which is a block diagram of a terminal capability reporting device according to an illustrative embodiment. The device includes a sending module 801.

The sending module 801 is configured to report first terminal capability to a base station, where the first terminal capability includes supporting a full-duplex communication mode.

In some examples, the device further includes a processing module.

The processing module is configured to determine that a terminal capability reporting condition is satisfied.

In some examples, the terminal capability reporting condition includes any of the following:
Radio Resource Control (RRC) connection reconfiguration is being performed;
RRC connection re-establishment is being performed;
RRC connection resume is being performed; or,
RRC connection is being setup.

In some examples, the sending module is further configured to report an RRC message including a first information element to the base station, where the first information element is used to indicate having the first terminal capability.

In some examples, the sending module is further configured to report an RRC message including first indication information to the base station, where the first indication information is used to indicate having the first terminal capability.

In some examples, the device further includes a receiving module.

The receiving module is configured to receive an RRC message sent by the base station for requesting second terminal capability.

The sending module is further configured to report the second terminal capability to the base station.

In some examples, the sending module is further configured to report an RRC message including a second information element to the base station, where the second information element includes the second terminal capability.

In some examples, the second terminal capability includes at least one of the following:
frequency information that supports the full-duplex communication mode;
time information that supports the full-duplex communication mode; and
a supported full-duplex communication mode.

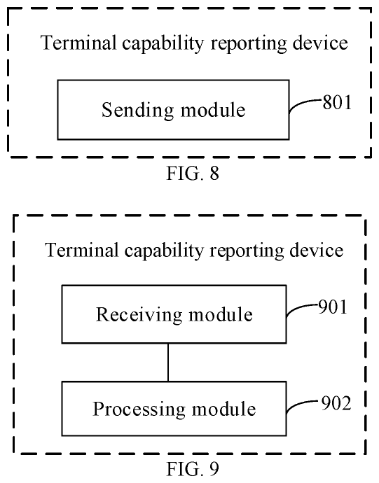

Refer to FIG. 9, which is a block diagram of another terminal capability reporting device according to an illustrative embodiment. The device includes a receiving module 901 and a processing module 902.

The receiving module 901 is configured to receive first terminal capability reported by a terminal, where the first terminal capability includes supporting a full-duplex communication mode.

The processing module 902 is configured to determine, based on the first terminal capability, that the terminal supports the full-duplex communication mode.

In some examples, the device further includes a sending module.

The sending module is configured to send an RRC message for requesting second terminal capability to the terminal.

The receiving module is further configured to receive the second terminal capability reported by the terminal.

In some examples, the sending module is further configured to send an RRC message including request information to the terminal, where the request information is used to request the second terminal capability.

In some examples, the second terminal capability includes at least one of the following:
frequency information that supports the full-duplex communication mode;
time information that supports the full-duplex communication mode; and
a supported full-duplex communication mode.

In some examples, the sending module is further configured to send second indication information to the terminal based on the second terminal capability, where the second indication information is used to indicate the full-duplex communication mode for the terminal.

For the device embodiments, since they basically correspond to the method embodiments, reference can be made to part of the description of the method embodiments. The device embodiments described above are merely illustrative, where the units described as separate components may or may not be physically separated, and the components displayed as units may be or may not be physical units, i.e., they can be located in one place, or they can be distributed on multiple network units. Some or all of the modules may be selected according to actual needs to achieve the objectives of the technical solutions of the present disclosure. Those ordinary skilled in the art can understand and implement them without any creative effort.

Correspondingly, the present disclosure also provides a computer-readable non-transitory storage medium for storing a computer program which, when being executed by a processor, is configured to implement any of the terminal capability reporting methods on the terminal side as described above.

Correspondingly, the present disclosure also provides a computer-readable non-transitory storage medium for storing a computer program which, when being executed by a processor, is configured to implement any of the terminal capability reporting methods on the base station side as described above.

Correspondingly, the present disclosure also provides a communication device, including:
a processor; and
a memory configured to store instructions executable by the processor,
wherein the processor is configured to perform any one of the terminal capability reporting methods on the terminal side described above.

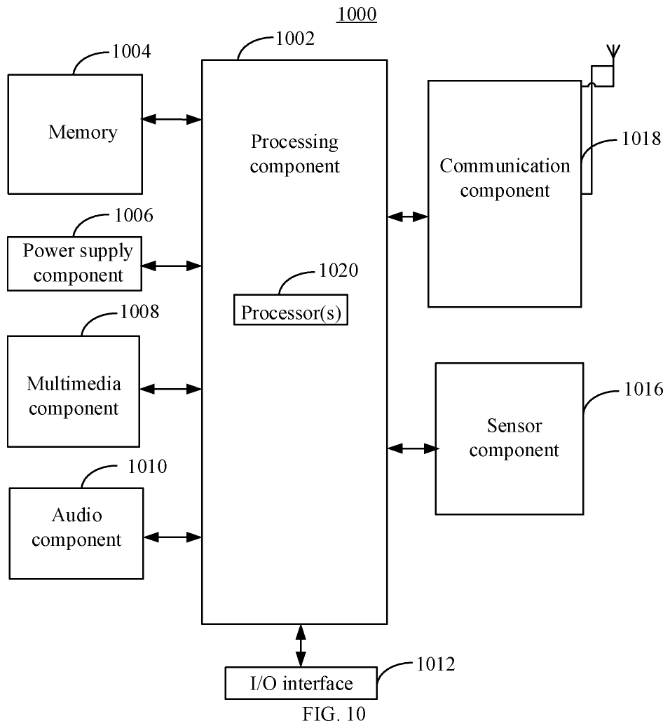

FIG. 10 is a block diagram of a communication device 1000 according to an illustrative embodiment. For example, the communication device 1000 may be a terminal such as a mobile phone, a tablet computer, an e-book reader, a multimedia playback device, a wearable device, a vehicle-mounted user equipment, an iPad, a smart TV or the like.

Referring to FIG. 10, the communication device 1000 may include one or more of the following components: a processing component 1002, a memory 1004, a power supply component 1006, a multimedia component 1008, an audio component 1010, an input/output (I/O) interface 1012, a sensor component 1016, and a communication component 1018.

The processing component 1002 generally controls the overall operations of the communication device 1000, such as operations associated with display, telephone calls, data random access, camera operations, and recording operations. The processing component 1002 may include one or more processors 1020 to execute instructions to complete all or part of the steps of the above terminal capability reporting methods. Additionally, the processing component 1002 may include one or more modules that facilitate interaction between the processing component 1002 and other components. For example, the processing component 1002 may include a multimedia module to facilitate interaction between the multimedia component 1008 and the processing component 1002. As another example, the processing component 1002 can read executable instructions from the memory to implement the steps of the terminal capability reporting method provided in the above embodiments.

The memory 1004 is configured to store various types of data to support operations on the communication device 1000. Examples of the data include instructions for any application or method operating on the communication device 1000, contact data, phone book data, messages, pictures, videos, etc. The memory 1004 can be implemented in any type of volatile or non-volatile storage device, or a combination thereof, such as a static random access memory (SRAM), an electrically erasable programmable read-only memory (EEPROM), an erasable Programmable read-only memory (EPROM), a programmable read-only memory (PROM), a read-only memory (ROM), a magnetic memory, a flash memory, a magnetic disk or an optical disk.

The power supply component 1006 provides power to various components of the communication device 1000. The power supply component 1006 may include a power management system, one or more power supplies, and other components associated with generating, managing, and distributing power for the communication device 1000.

The multimedia component 1008 includes a display screen that provides an output interface between the communication device 1000 and the user. In some embodiments, the multimedia component 1008 includes a front-facing camera and/or a rear-facing camera. When the communication device 1000 is in an operating mode, such as a shooting mode or a video mode, the front-facing camera and/or the rear-facing camera may receive external multimedia data. Each of the front-facing camera and the rear-facing camera can be a fixed optical lens system or have a focal length and optical zoom capabilities.

The audio component 1010 is configured to output and/or input audio signals. For example, the audio component 1010 includes a microphone (MIC). When the communication device 1000 is in an operation mode, such as a call mode, a recording mode or a voice recognition mode, the microphone is configured to receive external audio signals. The received audio signals may be further stored in the memory 1004 or sent via the communication component 1018. In some embodiments, the audio component 1010 further includes a speaker for outputting the audio signals.

The I/O interface 1012 provides an interface between the processing component 1002 and a peripheral interface module. The peripheral interface module may be a keyboard, a click wheel, a button, or the like. The button may include but is not limited to a home button, a volume button, a start button, and a lock button.

The sensor component 1016 includes one or more sensors for providing various state evaluations for the communication device 1000. For example, the sensor component 1016 can detect an on/off state of the communication device 1000 and relative positioning of a component such as a display or a keypad of the communication device 1000. The sensor component 1016 can also detect a position change of the communication device 1000 or a component of the communication device 1000, presence or absence of contact with the communication device 1000 by the user, orientation or acceleration/deceleration of the communication device 1000, and temperature changes of the communication device 1000. The sensor component 1016 may include a proximity sensor configured to detect presence of a nearby object without any physical contact. The sensor component 1016 may also include an optical sensor, such as a CMOS or CCD image sensor, for use in imaging applications. In some embodiments, the sensor component 1016 may also include an acceleration sensor, a gyroscope sensor, a magnetic sensor, a pressure sensor or a temperature sensor.

The communication component 1018 is configured to facilitate wired or wireless communication between the communication device 1000 and other devices. The communication device 1000 can access a wireless network based on a communication standard, such as a Wi-Fi, 2G, 3G, 4G, 5G, 6G or a combination thereof. In an illustrative embodiment, the communication component 1018 receives a broadcast signal or broadcast related information from an external broadcast management system via a broadcast channel. In an illustrative embodiment, the communication component 1018 further includes a near field communication (NFC) module to facilitate short-range communication. For example, the NFC module can be implemented based on a radio frequency identification (RFID) technology, an infrared data association (IrDA) technology, an ultra-wideband (UWB) technology, a Bluetooth (BT) technology or other technologies.

In an illustrative embodiment, the communication device 1000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform any one of the terminal capability reporting methods on the terminal side.

In an illustrative embodiment, there is also provided a non-transitory computer-readable storage medium including instructions, such as the memory 1004 including instructions. The instructions can be executed by the processor 1020 of the communication device 1000 to carry out the foregoing terminal capability reporting methods. For example, the non-transitory computer-readable storage medium may be a ROM, a random access memory (RAM), a CD-ROM, a magnetic tape, a floppy disk, an optical data storage device, etc.

Correspondingly, the present disclosure also provides a communication device, including:
a processor; and
   a. a memory configured to store instructions executable by the processor,
wherein the processor is configured to perform any one of the terminal capability reporting methods on the base station side described above.

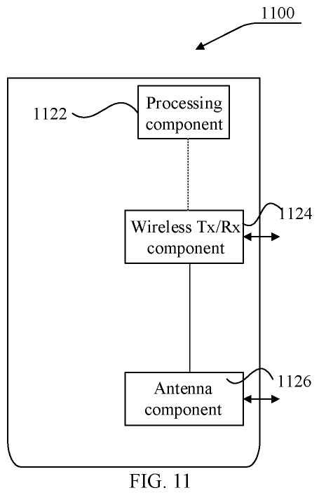

As shown in FIG. 11, FIG. 11 is a schematic structural diagram of a communication device 1100 according to an illustrative embodiment. The communication device 1100 may be provided as a base station. Referring to FIG. 11, the communication device 1100 includes a processing component 1122, a wireless transmitting/receiving component 1124, an antenna component 1126, and a signal processing part specific to a wireless interface. The processing component 1122 may further include at least one processor.

One of the processors in the processing component 1122 may be configured to perform any one of the terminal capability reporting methods on the base station side described above.

The technical solutions provided by the embodiments of the present disclosure can include the following beneficial effects.

In the present disclosure, the terminal may report the first terminal capability to the base station, where the first terminal capability includes supporting a full-duplex communication mode. Based on the first terminal capability, the base station determines that the terminal supports the full-duplex communication mode. Subsequently, the base station can determine a full-duplex communication mode that is more suitable for the terminal. The present disclosure can realize the purpose of reporting to the network side device that the terminal supports the full-duplex communication mode, and provides condition for applying the full-duplex technology in cellular networking.

After considering the description and practicing the present disclosure disclosed herein, those skilled in the art will readily contemplate other embodiments of the present disclosure. The present disclosure is intended to cover any variations, uses, or adaptions of the present disclosure that conform to the general principles of the present disclosure and include common knowledge or conventional technical means in the technical field which are not disclosed in the present disclosure. It is intended that the description and embodiments shall be considered as illustrative only, and the true scope and spirit of the present disclosure are indicated by the appended claims.

It should be understood that the present disclosure is not limited to the precise structures that have been described above and shown in the accompanying drawings, and various modifications and changes can be made without departing from the scope thereof. The scope of the present disclosure is defined only by the appended claims.

1. A terminal capability reporting method, wherein the method is performed by a terminal and comprises:
reporting first terminal capability to a base station, wherein the first terminal capability comprises supporting a full-duplex communication mode.

2. The method according to claim 1, wherein before reporting the first terminal capability to the base station, the method further comprises:
determining that a terminal capability reporting condition is satisfied.

3. The method according to claim 2, wherein the terminal capability reporting condition comprises any one of following conditions:
Radio Resource Control (RRC) connection reconfiguration is being performed;
RRC connection re-establishment is being performed;
RRC connection resume is being performed; or
RRC connection is being setup.

4. The method according to claim 1, wherein the reporting the first terminal capability to the base station comprises:
reporting an RRC message comprising a first information element to the base station, wherein the first information element is configured to indicate that the terminal having the first terminal capability.

5. The method according to claim 1, wherein the reporting the first terminal capability to the base station comprises:
reporting an RRC message comprising first indication information to the base station, wherein the first indication information is configured to indicate that the terminal has the first terminal capability.

6. The method according to claim 1, further comprising:
receiving an RRC message sent by the base station for requesting second terminal capability; and
reporting the second terminal capability to the base station.

7. The method according to claim 6, wherein the reporting the second terminal capability to the base station comprises:
reporting an RRC message comprising a second information element to the base station, wherein the second information element comprises the second terminal capability.

8. The method according to claim 6, wherein the second terminal capability comprises at least one of following capabilities:
frequency information that supports the full-duplex communication mode;
time information that supports the full-duplex communication mode; and
the supported full-duplex communication mode.

9. A terminal capability reporting method, wherein the method is performed by a base station and comprises:
receiving first terminal capability reported by a terminal, wherein the first terminal capability comprises supporting a full-duplex communication mode; and
determining, based on the first terminal capability, that the terminal supports the full-duplex communication mode.

10. The method according to claim 9, further comprising:
sending an RRC message for requesting second terminal capability to the terminal; and
receiving the second terminal capability reported by the terminal.

11. The method according to claim 10, wherein the sending the RRC message for requesting the second terminal capability to the terminal comprises:
sending the RRC message comprising request information to the terminal, wherein the request information is configured to request the second terminal capability.

12. The method according to claim 10, wherein the second terminal capability comprises at least one of the-following capabilities:
frequency information that supports the full-duplex communication mode;
time information that supports the full-duplex communication mode; and
the supported full-duplex communication mode.

13. The method according to claim 10, further comprising:
sending second indication information to the terminal based on the second terminal capability, wherein the second indication information is configured to indicate the full-duplex communication mode for the terminal.

14. A terminal device, comprising:
a processor; and
a memory configured to store instructions executable by the processor,
wherein the processor is configured to:
report first terminal capability to a base station, wherein the first terminal capability comprises supporting a full-duplex communication mode.

15. The terminal device according to claim 14,
wherein the processor is further configured to determine that a terminal capability reporting condition is satisfied.

16. The terminal device according to claim 15, wherein the terminal capability reporting condition comprises any one of following conditions:
Radio Resource Control (RRC) connection reconfiguration is being performed;
RRC connection re-establishment is being performed;
RRC connection resume is being performed; or
RRC connection is being setup.

17. The terminal device according to claim 14, wherein the processor is further configured to report an RRC message comprising a first information element to the base station, wherein the first information element is configured to indicate that the terminal has the first terminal capability.

18. The device according to claim 14, wherein the processor is further configured to report an RRC message comprising first indication information to the base station, wherein the first indication information is configured to indicate that the terminal having the first terminal capability.

19-26. (canceled)

27. A non-transitory computer-readable storage medium for storing a computer program, wherein the computer program, when being executed by a processor, is configured to implement the terminal capability reporting method according to claim 1.

28-29. (canceled)

30. A base station, comprising:
a processor; and
a memory configured to store instructions executable by the processor,
wherein the processor is configured to perform the terminal capability reporting method according to claim 9.
